(19) United States
(12) Patent Application Publication
(10) Pub. No.: US 2019/0342115 A1
(43) Pub. Date: Nov. 7, 2019

(54) METHOD FOR OPERATING A MONITORING DEVICE FOR A DATA NETWORK OF A MOTOR VEHICLE AND MONITORING DEVICE, CONTROL UNIT AND MOTOR VEHICLE

(71) Applicant: Conti Temic microelectronic GmbH, Nürnberg (DE)

(72) Inventors: Lorenz LIEDER, Biberach a.d. Riß (DE); Philipp NEUBAUER, Baienfurt (DE)

(21) Appl. No.: 16/479,513

(22) PCT Filed: Jan. 25, 2017
(86) PCT No.: PCT/EP2017/051523

§ 371 Date: Jul. 19, 2019

(30) Foreign Application Priority Data
Jan. 19, 2017 (DE) 10 2017 200 826.1

(51) Int. Cl. H04L 12/403; H04L 12/26

(52) U.S. Cl. CPC H04L 12/403; H04L 43/08; H04L 2012/40215; G05B 2219/2637; H04L 43/16

(57) ABSTRACT

Method for operating a monitoring apparatus of a data network in a motor vehicle, and monitoring apparatus, control device and motor vehicle

The invention relates to a method for operating a monitoring apparatus (23) of a data network (11) in a motor vehicle (10), wherein the monitoring apparatus (23) receives a data message (19) comprising at least one electrical signal (20, 21) from the data network (11) at a network connection (12). The invention provides for the monitoring apparatus (23) to determine at least one level value of a respective signal level of the at least one electrical signal (20, 21) in a predetermined message section of the message (19) and to generate a test value on the basis of the at least one level value and to determine, for the data message (19), an item of sender information indicating an alleged sender device of the data message (19) and to determine a reference value on the basis of the sender information, and to generate a warning signal (28) if a difference between the test value and the reference value is greater, in terms of absolute value, than a predetermined threshold value. The signal level of the electrical signal is attenuated or generally changed by the impedance which results for the line section connecting the sender device and the monitoring apparatus (23). Use is made of the fact that characteristic attenuations on the lines between the individual control devices (ECUs), which are largely fixed and therefore deterministic in static networks, apply in a network. The monitoring apparatus therefore provides a method and an apparatus in which amplitudes or amplitude differences of bus signals from a transmitting station ECU X (14, 15, 16) are captured in a network at a receiving station ECU M (13), are compared with an expected amplitude or amplitude difference and are used to detect an anomaly. This makes it difficult for a sender device to conceal an incorrect item of sender information.

Method for operating a monitoring apparatus of a data network in a motor vehicle, and monitoring apparatus, control device and motor vehicle

The invention relates to a method for operating a monitoring apparatus in a data network in a motor vehicle. The monitoring apparatus detects if a data message is transmitted by an incorrect sender in the data network. The invention also includes the monitoring apparatus, a motor vehicle control device having the monitoring apparatus and a motor vehicle having the control device.

A monitoring apparatus can be provided in a motor vehicle in order to detect an anomaly in the transmission behavior of a network subscriber in a data network. An anomaly can be attributed, for example, to a manipulation attempt in which a network subscriber, that is to say a control device for example, emits a data message using an incorrect sender. As a result, the network subscriber appears as another network subscriber. This can be carried out, for example, as part of an attempt to tune the motor vehicle in an unauthorized manner. An incorrect configuration may also result in a network subscriber transmitting a data message which it is not intended to emit at all because another network subscriber is provided for this.

In connection with the invention, said data network should be understood as meaning, for example, a CAN bus (CAN—Controller Area Network), a FlexRay bus, an Ethernet network, a MOST bus, a USB bus or a combination of at least two different technologies of the network technologies mentioned.

The invention is based on the object of monitoring a data network in a motor vehicle for incorrect data messages.

The object is achieved by the subject matter of the independent patent claims. Advantageous developments of the invention are described by the dependent patent claims, the following description and the figures.

The invention provides a method for operating a monitoring apparatus for the data network in the motor vehicle. The monitoring apparatus may be provided, for example, as an additional circuit in a control device of the motor vehicle. The method provides for the monitoring apparatus to receive a data message from the data network at a network connection. Although such a data message is a digital signal, it is transmitted as at least one electrical signal on the physical level (PHY). The data message therefore comprises at least one such electrical signal. At least one level value of a respective signal level of the at least one electrical signal is determined in a predetermined message section of the message. A voltage level or a current level, for example, can be captured as the signal level. The level value then accordingly indicates the voltage amplitude or the current amplitude. A test value is generated on the basis of the at least one level value. In other words, if a plurality of level values are captured, they are combined to form a single test value. In the case of an individual captured level value, the latter can be used as the test value.

Furthermore, an identifier or an item of sender information indicating the alleged sender device of the data message is determined for the data message. The alleged sender device is another network subscriber, that is to say a control device for example, from which the data message could potentially originate and also allegedly originates according to the sender information. Another term for a network subscriber is also a station. The intention is now to check whether the sender information is correct. For this purpose, a reference value is determined, for example, from a data memory of the monitoring apparatus on the basis of the sender information. This reference value relates to the test value.

A warning signal is generated if a difference between the test value and the reference value is greater than a predetermined threshold value. In this case, the difference is preferably captured in terms of absolute value, with the result that it does not make any difference whether the test value is greater than or less than the reference value.

In order to detect an incorrect item of sender information, the invention uses the fact that the at least one level value is changed, during transmission via the data network, by the line section or the line segment used to electrically connect the sender device to the monitoring apparatus. The sender device can generate the at least one electrical signal, for example, according to a rule or standard for the communication of the data network, that is to say can set a standard level value for the at least one electrical signal. However, the respective signal level of the at least one electrical signal is attenuated or generally changed by the impedance which results for the line section connecting the sender device and the monitoring apparatus. This is because the impedance may have an inductive, capacitive and/or resistive component, each of which may influence the at least one electrical signal. The reference value can indicate what test value can be expected by the monitoring apparatus if the data message was emitted by the correct sender device. In contrast, if the data message is emitted into the data network by another sender device, a different line section is situated between the sender device transmitting in an unauthorized manner and the monitoring apparatus. This line section has a different impedance, for example on account of a different line length, with the result that a respective different level value accordingly also results for the at least one electrical signal than would be the case if the correct sender device emitted the data message.

The invention results in the advantage that a data message with falsified sender information is detected on the physical level on the basis of the measurement of at least one level value. This makes it difficult for a sender device to conceal an incorrect item of sender information. Another advantage is that it suffices to provide the monitoring device without having to adapt or change the transmission behavior and/or circuit design of other network subscribers, that is to say other control devices, in order to be able to provide the monitoring according to the invention in the data network.

The invention also includes developments which result in additional advantages.

In a data network which provides for the data message to comprise two electrical signals of a differential transmission (two electrical signals in phase opposition), a maximum value of one signal and a minimum value of the other signal are preferably determined as the respective level value of these two signals. The monitoring apparatus calculates a level difference value of a level difference between the maximum value and the minimum value. The highest signal level and the lowest signal level are therefore determined. Two level values of the two differential signals can generally be used. The test value is determined on the basis of the level difference. For example, the level difference can be used directly as the test value. This development makes it possible to take into account two electrical signals when monitoring the data network.

According to one development, not only the monitoring apparatus itself but additionally another network subscriber, that is to say another control device for example, generates such a level difference value. In this development, the monitoring apparatus accordingly receives, via the data network, the further level difference value of the further level difference of the two signals, as determined in the data network. The test value is then determined on the basis of a quotient of the two level difference values. This results in two advantages. On the one hand, the test value is thereby independent of the signal level used by the sender device. This means that there is independence of manufacturing tolerances, with the result that the replacement of a sender device does not result in corruption of the test value, and the reference value therefore always results for the correct sender device again. Another advantage is that a level difference is respectively determined at two points in the data network, that is to say at two network connections. The situation is therefore prevented in which a falsified item of sender information could remain undetected by the monitoring apparatus because the unauthorized sender device randomly is at the same distance from the monitoring apparatus as the correct sender device and the line sections would therefore be of the same length.

In order to determine the sender information, provision may be made for the monitoring apparatus to read the sender information from the data message. This is possible if the data message contains an item of information for the sender device, for example its network address. Alternatively, provision may be made for the monitoring apparatus to determine the sender information from a predefined configuration plan of the data network on the basis of a message type of the data message. For example, the data message may contain a value of a particular measurement variable, for example a steering angle. A data message of a given message type (“steering angle”) can intentionally originate only from a predetermined sender device according to the configuration plan. An item of sender information can therefore also be determined in this manner.

A further issue is how the reference value can be provided in the motor vehicle. The reference value can be generated in a calibration phase by virtue of the monitoring apparatus receiving, via the data network, a reference message from a known sender device, the actual sender information of which is known. The test value can likewise be calculated for the reference message in the described manner. The calculated test value is then used as the reference value which is stored in the data memory, for example. The calibration phase can be carried out, for example, during the production of the motor vehicle or during a stop at a repair shop if it can be ensured that there is no manipulation in the data network during the calibration phase. Measuring a reference value has the advantage that manufacturing tolerances can be taken into account in the reference value and can therefore be implicitly compensated for during monitoring.

Alternatively, the reference value can also be calculated. In this respect, the reference value can be calculated on the basis of an impedance value of the line segment of the data network, which line segment electrically connects the monitoring apparatus to the known sender device. If a second test value is not determined by another control device, the reference value can be additionally effected on the basis of a standard level value of the standard level used by the known sender device when generating the at least one electrical signal, for example for current or voltage, in particular said maximum value and minimum value.

In order to obtain a meaningful level value, a predetermined message section is used in the described manner. One development provides for the monitoring apparatus to determine a predetermined signal bit of the data message as the predetermined message section. Which signal bit is suitable here depends on the communication protocol used in the data network. A signal bit in which a signal level has said maximum value is preferably used.

In order to carry out the monitoring with little technical complexity, provision is preferably made for the monitoring apparatus to generate the at least one level value by means of a sample-and-hold circuit and by means of an analog/digital converter connected downstream of the latter. The monitoring apparatus can therefore concomitantly read, that is to say capture by means of the sample-and-hold circuit, the predetermined message section, that is to say can store the respective signal level of the at least one electrical signal, for example in a respective capacitor, without the data message hereby being lost for use by a control device.

Accordingly, provision is made for the monitoring apparatus to preferably be operated as an additional circuit in a control device of the motor vehicle. A control device actually has an application circuit, by means of which the control device can provide a vehicle function specific to the control device, for example actuator control or capture of measured values by means of sensors or driver assistance. Such a vehicle function can therefore be, for example, the control of an electric motor for power-assisted steering and/or driver assistance for driving stability control. In order to provide the vehicle function, this application circuit of the control device receives the data message via the same network connection, to be precise independently of the monitoring circuit. In the described manner, the monitoring apparatus therefore only concomitantly reads the data message and monitors whether it originates from the correct sender device. The control device is therefore protected from falsified data messages.

The invention also provides for said monitoring apparatus to be provided for the data network in the motor vehicle. For this purpose, the monitoring apparatus has an electronic circuit which is set up to carry out an embodiment of the method according to the invention. For example, an electronic circuit having said sample-and-hold circuit, the analog/digital converter and a downstream processor device (for example a microprocessor or a microcontroller) can be provided. The method may also comprise program code, for example, in order to be able to carry out said calculation steps.

It is particularly advantageous if the monitoring apparatus is implemented as an integral constituent part of a control device for a data network in the motor vehicle. Accordingly, the invention also provides such a control device which has a network connection for connecting the control device to the data network, wherein both the described application circuit for providing a vehicle function and, independently of this, an embodiment of the monitoring apparatus according to the invention are connected to the network connection.

Finally, the invention also comprises a motor vehicle having a data network to which an embodiment of the control device according to the invention is connected, that is to say a control device having the monitoring apparatus. Furthermore, at least one further network subscriber, that is to say a further control device for example, is connected to the data network. The further network subscriber is set up to emit at least one data message. The control device according to the invention can be used in the motor vehicle to detect whether a data message received by the control device actually originates from the network subscriber.

The motor vehicle according to the invention is preferably designed as an automobile, in particular as a passenger vehicle or a truck.

An exemplary embodiment of the invention is described below. To this end, in the figures:

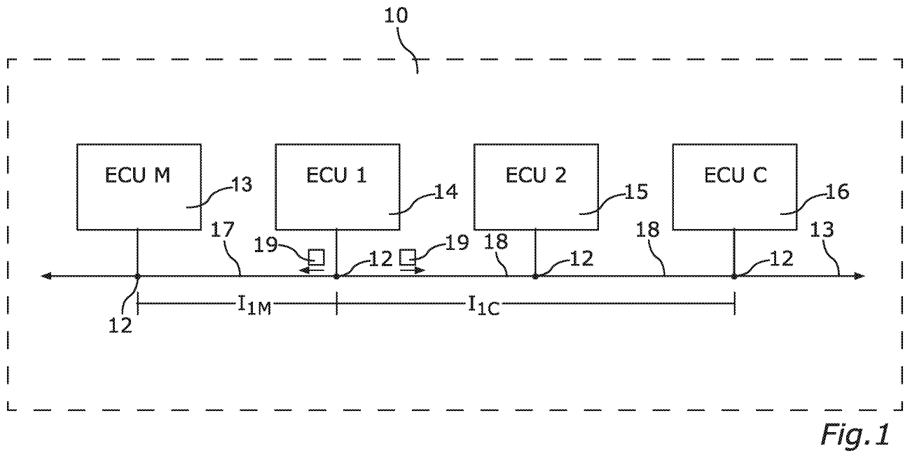

FIG. 1 shows a schematic illustration of an embodiment of the motor vehicle according to the invention;

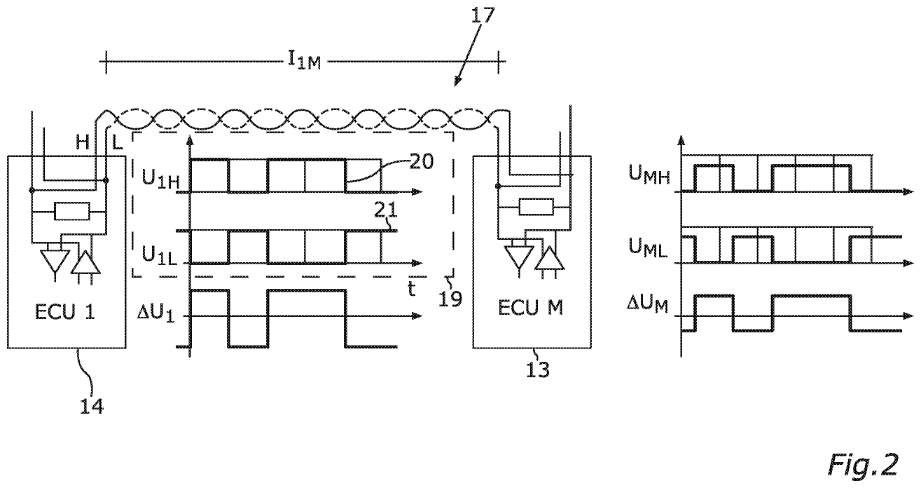

FIG. 2 shows a schematic illustration of two control devices which communicate via a data network in the motor vehicle from FIG. 1;

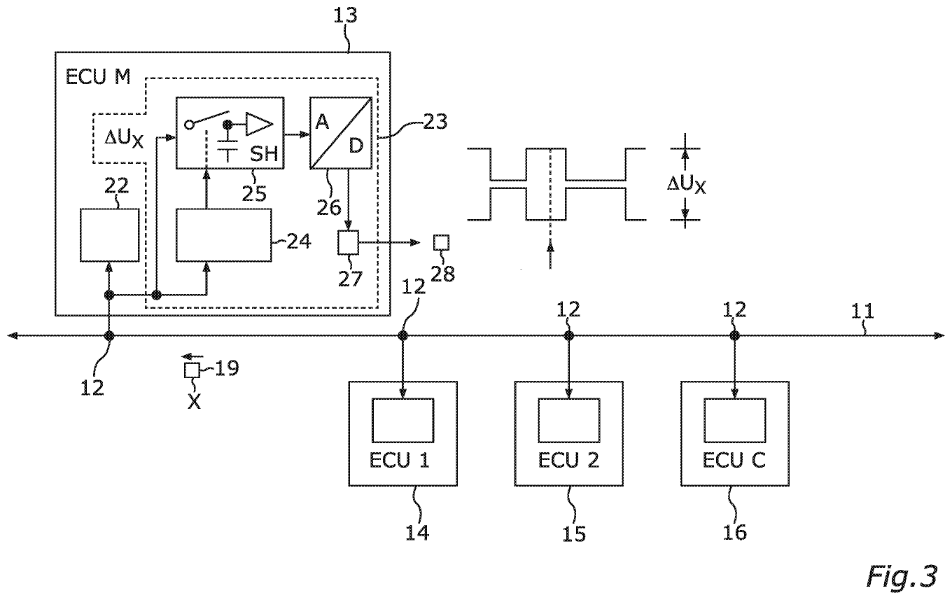

FIG. 3 shows a schematic illustration of an internal structure of one of the control devices which has a monitoring apparatus for the data network.

The exemplary embodiment explained below is a preferred embodiment of the invention. In the exemplary embodiment, the described components of the embodiment each constitute individual features of the invention which should be considered independently of one another and which in each case also develop the invention independently of one another and should therefore also be regarded as a constituent part of the invention individually or in a different combination to that shown. Furthermore, the embodiment described may also be supplemented by further features of the invention from among those that have already been described.

In the figures, functionally identical elements are provided with the same reference signs in each case.

FIG. 1 shows a motor vehicle 10 which may be an automobile, in particular a passenger vehicle or a truck. The motor vehicle 10 may have a data network 11 which may be a CAN bus or a FlexRay bus, for example. A control device 13, 14, 15, 16 can be respectively connected to the data network 11 via a respective network connection 12. The control devices 13, 14, 15, 16 are distinguished from one another by a respective individual designation (ECU M, ECU 1, ECU 2, ECU C). The control device 13 (ECU M) may be, for example, a bus master for the data network 11. The control devices ECU 1, ECU 2 may each provide a sensor device and/or actuator control, for example. The control device 16 may be a further network subscriber (C—client).

FIG. 1 illustrates that a respective line segment 17 having a line length 1_1M can electrically connect the control device ECU 1 to the control device ECU M and a line segment 18 having a line length 1_1C can electrically connect the control device ECU 1 to the control device ECU C.

In order to transmit a data message 19, the control device ECU 1, for example, can generate electrical signals in the respective line segment 17, 18, which signals can be received via the respective network connection 12 of the control devices ECU M and ECU C (and also ECU 2).

In this case, FIG. 2 illustrates the influence of the line segment 17 when transmitting the data message 19 from the control device ECU 1 to the control device ECU M. Provision may be made for two electrical signals 20, 21 to be generated in a high line H and a low line L for the differential transmission of a data message 19, as is known in connection with the technology of the CAN bus and the FlexRay bus.

FIG. 3 illustrates how, in addition to the actual application circuit 22, a monitoring apparatus 23 can be provided, for example, in the control device ECU M and can capture the electrical signals 20, 21 received via the network connection independently of the application circuit 22. For this purpose, the monitoring apparatus 23 may have selection logic 24, a sample-and-hold circuit 25, an analog/digital converter 26 and a processor device 27, for example a microcontroller. The processor device 27 may be a constituent part of the application circuit 22. The analog/digital converter 26 may already be a constituent part of a microcontroller which constitutes the processor device 27.

If the control device ECU M receives a data message 19 which was not emitted by the respective control device 14, 15 intended to generate the specific data message 19 of the corresponding message type, the monitoring apparatus 23 identifies this data message 19 as falsified or incorrect and can then generate a warning signal 28 which can indicate this falsified data message 19.

For this purpose, the monitoring apparatus 23 can carry out a method for detecting anomalies in a network. In this case, the source of a message 19 in the network 11 is verified by means of a characteristic pattern which is given only by physical boundary conditions such as the attenuation on a propagation medium, for instance on an electrical line, and can therefore be falsified only with great difficulty. The network may be the CAN bus, FlexRay, Ethernet, MOST, to illustrate the broad possible use of the approach.

Amplitudes or amplitude differences of the bus signal are captured at suitable times and, after successful reception, are compared with the expected pattern of the authorized sender device. If these patterns correspond, the normal situation is present, that is to say the message therefore originates from the authorized sender device. In the other case, an anomaly can be determined; it was detected that a message was not transmitted by the authorized sender device as the source of the message 19. Attacks can be effectively detected with the aid of anomaly detection and can be averted in a further step. In the monitoring apparatus 23, the voltage (possibly also the current) on the bus line is immediately checked under signal, that is to say the message contents are not decoded in the anomaly detection described here, apart from the identifier which is used as the sender information in order to assign the characteristic pattern to a signal source.

No periodicity of the messages to be examined is expected for the method. No cooperation whatsoever of the transmitting network subscriber is presupposed either, that is to say the transmitting sender device need not transmit any additional information, for instance time stamps. Furthermore, the method is used to strive to keep the additional outlay low, for instance by virtue of the fact that the vast majority of the electronic control devices do not require any modification whatsoever.

Use is made of the fact that characteristic attenuations on the lines between the individual ECUs, which are largely fixed and therefore deterministic in static networks, apply in a network.

If, as illustrated in FIG. 2, the ECU 1 transmits a message, this is carried out by means of differential line transmission, for example in the case of the CAN bus or in the case of FlexRay. One of the two symmetrical bus lines is modulated with a level U_{1H} and the other line is modulated with an opposite level U_{1L}. Only a single, ideally terminated line segment 17 is illustrated here by way of example.

According to FIG. 2, the voltage U_{1H}(t,l) or U_{1L}(t,l) propagates on the line as an attenuated wave, and said voltages are received by ECU M as attenuated, smaller voltages U_{MH} and U_{ML}, thus resulting in the differences

ΔU1=U_{1H}−U_{1L} (1)

ΔUM=U_{MH}−U_{ML} (2)

ΔU_{M}=ΔU₁·10^{(0.1·α·1_1M)} (3)

The coefficient α here expresses the attenuation of the line in dB/m, and l_1M=l_{1M} expresses the line length between ECU 1 and ECU M in the case of low-reflection termination (low-reflection termination should always be ensured here).

The amplitude difference at the receiving ECU is therefore initially determined by the transmitting ECU and then decreases exponentially over the line length l_{1M}. Typical absolute values for α are of the order of magnitude of 0.1 to 0.3 dB/m.

It is now assumed that a control device ECU X emits, at any desired time, a message which is received by all ECUs connected to the data network, in particular by the ECU M. In this case, X may be 1 or 2, for example. For the data message 19 from the as yet unknown control device ECU X, the monitoring apparatus 23 determines a level difference of ΔU_{M}=ΔU_{X}.

For particular identifiers of safety-critical messages, for instance the steering angle or the throttle valve position, ECU M can now compare the currently determined amplitude difference ΔU_{X} (actual) of the bus levels with an expected amplitude difference ΔU_{X} (expected) according to the method and can assess a deviation as an anomaly

Apat(X)=ΔU_{X} (actual)−ΔU_{X} (expected) (4)

In an undesirable, that is to say safety-critical, situation, ECU Y would now transmit a message 28 which allegedly originates from ECU X (Y not equal to X). In the case of the CAN bus, this would be the case, for example, if ECU Y uses a CAN identifier which is normally assigned exclusively to ECU X. In a conventional network, this improper use of a CAN identifier might not be recognized. Such a situation arises, for instance, during “hacking” of an ECU Y from which falsified CAN messages are emitted

if (|Apat(x)|>Limit)→Anomaly (5)

In order to determine a characteristic amplitude difference according to (2), a suitable time must be selected. This can be carried out with the aid of the selection logic for determining a suitable signal property, for example a particular bit of a message 19 after the starting edge.

In a network having any desired number of ECUs, a master ECU M is preferably provided with the monitoring apparatus 23 which allows the amplitude difference ΔUX of the bus signal from the unknown source ECU X to be captured by selection logic 24 at the time at which a previously stipulated bit arrives, here by means of the sample-and-hold 25 and the downstream AD converter 26. The other ECUs do not require such an apparatus.

According to (3), the amplitude difference at a receiving ECU 1 is also dependent on the amplitude difference ΔU₁ available to the transmitting ECU 1. This voltage can vary greatly under the influence of series variation, ageing and the temperature. In contrast, the attenuation on the line is rather constant. An improvement is therefore obtained if amplitude or amplitude difference patterns are captured at two separate ECUs, for instance at ECU M and ECU U, and attenuation-dependent D(X) is therefore captured as a characteristic pattern of a transmitting ECU X by means of (6):

ΔU_{M} (X)=ΔU_{X}·10^{(0.1·α·l_MX)}

ΔU_{C} (X)=U_{X}·10^{(0.1·α·l_CX)}

D(X)=U_{M} (X)/ΔU_{C} (X)=10^{(0.1·α·l_MX-l_CX)}

where l_MX 32 l_{MX} is the length of the line segment between ECU M and ECU X and l_CX=l_{CX} is the length of the line segment between ECU C and ECU X.

For particular identifiers of safety-critical messages, for instance the steering angle or the throttle valve position, ECU M can compare the currently determined attenuation pattern D (X,actual) with the expected attenuation pattern D (X,expected), with knowledge of the amplitude difference determined in a second ECU C, according to the method for message X and can assess a deviation as an anomaly

Dpat(X)=D(X, actual)−D(X, expected) (7)

In a safety-critical situation, ECU Y would now transmit a message Y which allegedly originates from ECU X. In the case of the CAN bus, this would be the case, for example, if ECU Y uses a CAN identifier which is normally assigned exclusively to ECU X. In a conventional network, this improper use of a CAN identifier might not be recognized. Such a situation arises, for instance, during “hacking” of an ECU Y from which falsified CAN messages are emitted

if (|Dpat(X)|>Limit)->Anomaly (8)

The monitoring apparatus therefore provides a method and an apparatus in which amplitudes or amplitude differences of bus signals from a transmitting station ECU X are captured in a network at a receiving ECU M, are compared with an expected amplitude or amplitude difference and are used to detect an anomaly. Network signals are preferably evaluated at a point in the network, referred to here as ECU M, with regard to the bus level (voltage or current) of a particular bit of the message. The bus level or signal level is preferably captured (sampled) in ECU M and is assigned to a network message X, for instance its identifier. The bus levels of a message X which are captured in ECU M are preferably calculated to form a level difference. The captured bus levels of a reference message R transmitted by a known station ECU C (or ECU M) are preferably calculated with the bus levels for the message X to form an attenuation or amplitude pattern or amplitude difference pattern. The determined level difference or attenuation pattern is preferably compared with an expected pattern, and a deviation is assessed as an anomaly by means of a threshold value decision. The bus level is preferably captured at the time at which a particular bit arrives in ECU M or ECU C and an analog filter having a peak-hold circuit (as a sample-and-hold circuit) is used for the purpose of interpolation, this interpolated value is likewise captured by an analog/digital converter and is assigned to a network message X.

Overall, the example shows how amplitude monitoring in a network can be provided by the invention.

### LIST OF REFERENCE SIGNS

10 Motor vehicle

11 Data network

12 Network connection

13 Control device

14 Control device

15 Control device

16 Control device

17 Line segment

18 Line segment

19 Data message

20 Electrical signal

21 Electrical signal

22 Application circuit

23 Monitoring apparatus

24 Selection logic

25 Sample-and-hold circuit

26 Analog/digital converter

27 Processor device

28 Warning signal

1. A method for operating a monitoring apparatus of a data network in a motor vehicle, wherein the monitoring apparatus receives a data message comprising at least one electrical signal from the data network at a network connection, wherein the monitoring apparatus:
determines at least one level value of a respective signal level of the at least one electrical signal in a predetermined message section of the data message,
generates a test value based on the at least one level value,
determines, for the data message, an item of sender information indicating an alleged sender device of the data message,
determines a reference value based on the sender information, and
generates a warning signal if a difference between the test value and the reference value is greater, in terms of absolute value, than a predetermined threshold value.

2. The method as claimed in claim 1, wherein the data message comprises two electrical signals, the two electrical signals comprising a first signal and a second signal, the second signal being other than the first signal, of a differential transmission, and the monitoring apparatus calculates a first level difference value of a level difference between the first signal and the second signal, and the test value is determined based on the first level difference value.

3. The method as claimed in claim 2, wherein the monitoring apparatus receives, via the data network, a second level difference value of a further level difference of the at least one electrical signal in the data message, as determined at another network connection, and determines the test value based on a quotient of the first and second level difference values.

4. The method as claimed in claim 1, wherein the monitoring apparatus reads the sender information from the data message or determines the sender information it from a predefined configuration plan of the data network based on a message type of the data message.

5. The method as claimed in claim 1, wherein the respective signal level is a voltage level or a current level.

6. The method as claimed in claim 1, wherein the reference value is generated in a calibration phase by virtue of the monitoring apparatus receiving, via the data network, a reference message from a known sender device, the sender information of which is known, and calculating the test value for the reference message and storing the calculated test value as the reference value, or wherein
the reference value is calculated based on an impedance value of a line segment of the data network, which line segment electrically connects the monitoring apparatus to the known sender device.

7. The method as claimed in claim 1, wherein the monitoring apparatus determines a predetermined signal bit of the data message as the predetermined message section.

8. The method as claimed in claim 1, wherein the monitoring apparatus generates the at least one level value by a sample-and-hold circuit and an analog/digital converter connected downstream of the sample-and-hold circuit.

9. The method as claimed in claim 1, wherein the monitoring apparatus is operated as an additional circuit in a control device of the motor vehicle, wherein an application circuit of the control device receives the data message for providing a vehicle function via same network connection independently of the monitoring apparatus.

10. A monitoring apparatus for a data network in a motor vehicle, wherein the monitoring apparatus has an electronic circuit which is configured to carry out a method as claimed in claim 1.

11. A control device for a data network in a motor vehicle, wherein the control device has a network connection for connecting the control device to the data network, and an application circuit for providing a vehicle function and, independently thereof, a monitoring apparatus as claimed in claim 10 are connected to the network connection.

12. A motor vehicle having a data network, to which a control device as claimed in claim 11 and at least one network subscriber configured to emit data messages are connected.
